(19) United States
(12) Patent Application Publication
(10) Pub. No.: US 2023/0376837 A1
(43) Pub. Date: Nov. 23, 2023

(54) DEPENDENCY CHECKING FOR MACHINE LEARNING MODELS

(71) Applicant: ORACLE INTERNATIONAL CORPORATION, Redwood Shores, CA (US)

(72) Inventors: Matthew T. GERDES, Oakland, CA (US); Kenneth P. BACLAWSKI, Waltham, MA (US); Dieter GAWLICK, Palo Alto, CA (US); Kenny C. GROSS, San Diego, CA (US); Guang Chao WANG, San Diego, CA (US); Anna CHYSTIAKOVA, Palo Alto, CA (US); Richard P. SONDEREGGER, Dorchester, MA (US); Zhen Hua LIU, San Mateo, CA (US)

(21) Appl. No.: 17/751,083

(22) Filed: May 23, 2022

(51) Int. Cl. G06N 20/00

(52) U.S. Cl. CPC G06N 20/00

(57) ABSTRACT

Systems, methods, and other embodiments associated with associated with dependency checking for machine learning (ML) models are described. In one embodiment, a method includes applying a repeating probe signal to an input signal input into a machine learning model. An estimate signal output from the machine learning model is monitored, and the repeating probe signal is checked for in the estimate signal. Based on the results of the checking for the repeating probe signal, an evaluation of dependency in the machine learning model is presented.

### BACKGROUND

Large numbers of sensors may be used to monitor the operations of a wide variety of assets, such as data centers, passenger aircraft, and oil refineries. The time series sensor data or signals from the sensors can be used in machine learning (ML) time series prognostic surveillance to detect incipient failure of the monitored asset before the failure occurs. This makes it possible to take corrective action before failure of the monitored asset. The usefulness of such predictions depends heavily on the accuracy of the ML model predictions. Inaccurate ML model predictions by poor ML models detract from prognostic surveillance, either through excessive false alarms or excessive missed alarms. False alarms may be confusing or wasteful, while missed alarms may be catastrophic and deadly.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a system associated with dependency checking for machine learning (ML) models.

FIG. 2 illustrates one embodiment of a dependency checking method 200 associated with dependency checking for ML models.

FIG. 3 illustrates a plot of results of a transfer function analysis for a first example signal database of time series data. The transfer function analysis is associated with dependency checking for machine learning (ML) models.

FIG. 4 illustrates a plot of results of a transfer function analysis for a second example signal database of time series data. The transfer function analysis is associated with dependency checking for machine learning (ML) models.

FIG. 5 illustrates an embodiment of a computing system configured with the example systems and/or methods disclosed.

### DETAILED DESCRIPTION

Systems, methods and other embodiments are described herein that provide dependency checking and detection for machine learning (ML) models. For context, ML time series prognostics may operate by training a ML model to learn correlations among time series signals of a monitored system, using the trained ML model to predict “expected,” “normal,” or “correct” values for time series signals, and issuing alerts for deviations between observed and predicted signal behavior. Dependency phenomena (as discussed in further detail elsewhere herein) can reduce the accuracy of the predicted values in ways that cause missed alerts and false alerts.

In one embodiment, a model dependency check system identifies the presence or absence of undesirable dependency phenomena in a trained ML model. In one embodiment, a model dependency check system looks for dependencies in a trained ML model by applying an oscillation to an input (or test) signal provided as input to the ML model, and checking for the oscillation in estimate signal(s) output from the ML model.

In one embodiment, a model dependency check system applies an oscillating perturbation to a test signal that is input into a machine learning model. The model dependency check system then monitors an estimate signal that is output from the machine learning model. The model dependency check system checks for the oscillating perturbation in the estimate signal. From the results of the check, the model dependency check system may then present an evaluation of dependency in the ML model.

For example, an ML model may be subject to a dependency phenomena called “following” that can cause excessive missed-alarm probabilities (MAPs). In another example, an ML model may be subject to a dependency phenomena called “spillover” that causes excessive false-alarm probabilities (FAPs). As used herein, the term dependency refers collectively to following and spillover. The following and spillover dependency phenomena are described in further detail elsewhere herein. In one embodiment, both the following and the spillover dependencies may be detected by the model dependency check system.

### Example Model Dependency Check System

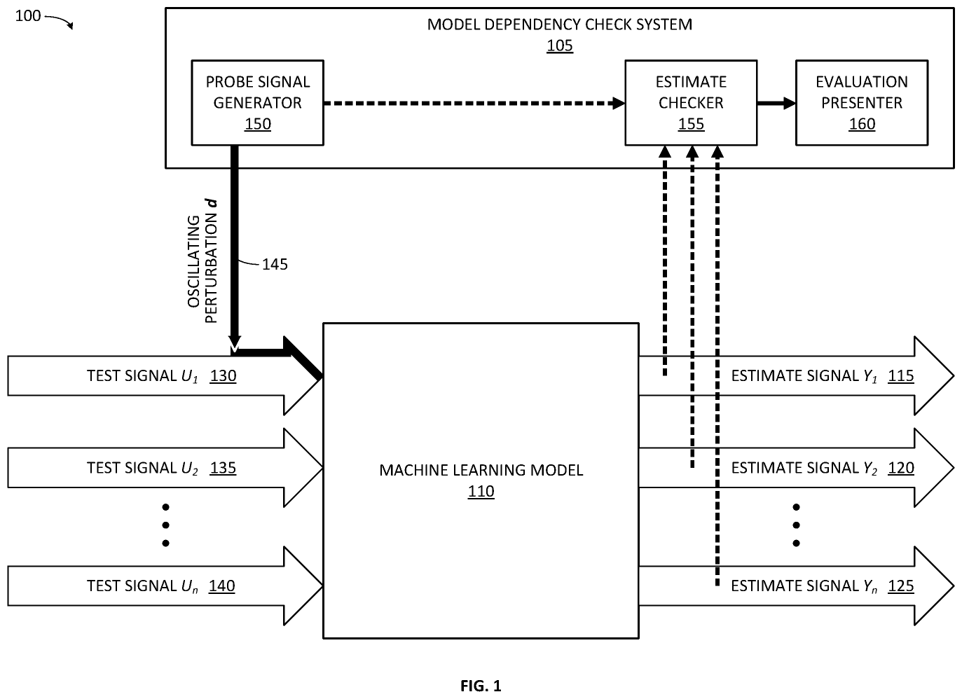

FIG. 1 illustrates one embodiment of a system 100 associated with dependency checking for machine learning (ML) models. System 100 includes a model dependency check system 105 configured to check for dependencies in a machine learning model 110. In one embodiment, machine learning model 110 has been trained to generate a set of n estimate signals 115, 120, 125 from a set of n test signals 130, 135, 140.

In one embodiment, the model dependency check system 105 is configured to apply an oscillating perturbation d 145 (or other repeating probe signal) to a test signal (such as test signal U₁ 130) that is input into ML model 110. In one embodiment, model dependency check system 105 includes a probe signal generator 150 that is configured to provide oscillating perturbation d 145.

In one embodiment, the model dependency check system 105 is configured to monitor one or more of the n estimate signals 115, 120, 125 that are output from the ML model 110. In one embodiment, the model dependency check system 105 is configured to collect the values of the n estimate signals 115, 120, 125 and store them for subsequent analysis.

In one embodiment, the model dependency check system 105 is configured to check for the oscillating perturbation d 145 in the one or more of the n estimate signals 115, 120, 125. In one embodiment, model dependency check system 105 includes an estimate checker 155 that is configured to examine one or more of the n estimate signals 115, 120, 125 for the presence of the oscillating perturbation d 145.

In one embodiment, the model dependency check system 105 is configured to present an evaluation of dependency in the machine learning model. In one embodiment, the evaluation is based on results of checking for the oscillating perturbation d 145 in the one or more of the n estimate signals 115, 120, 125. In one embodiment, model dependency check system 105 includes an evaluation presenter 160 that is configured to output information regarding the nature and extent of dependency detected in the ML model outputs.

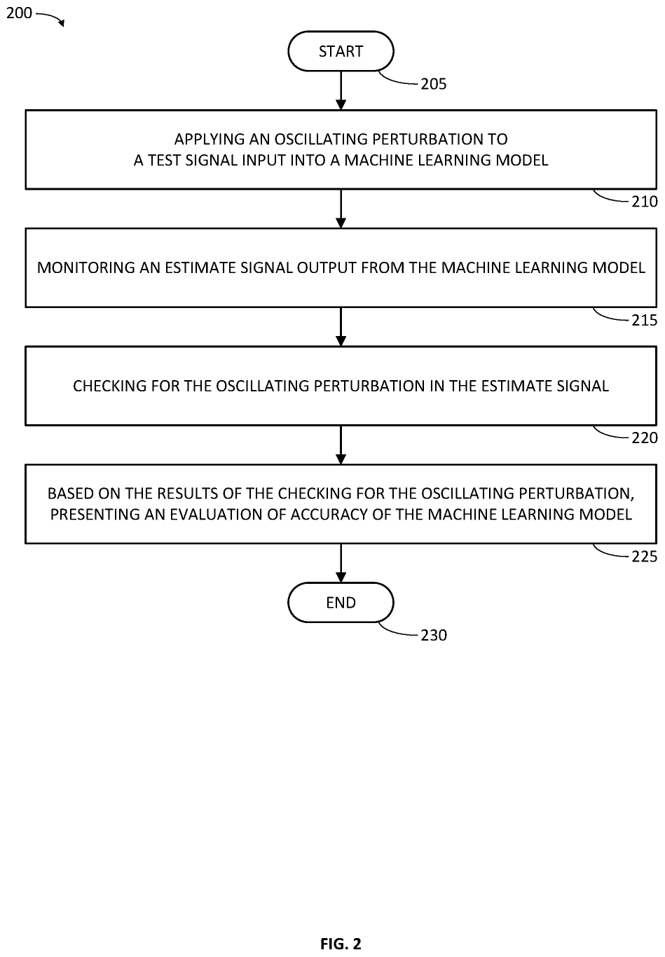

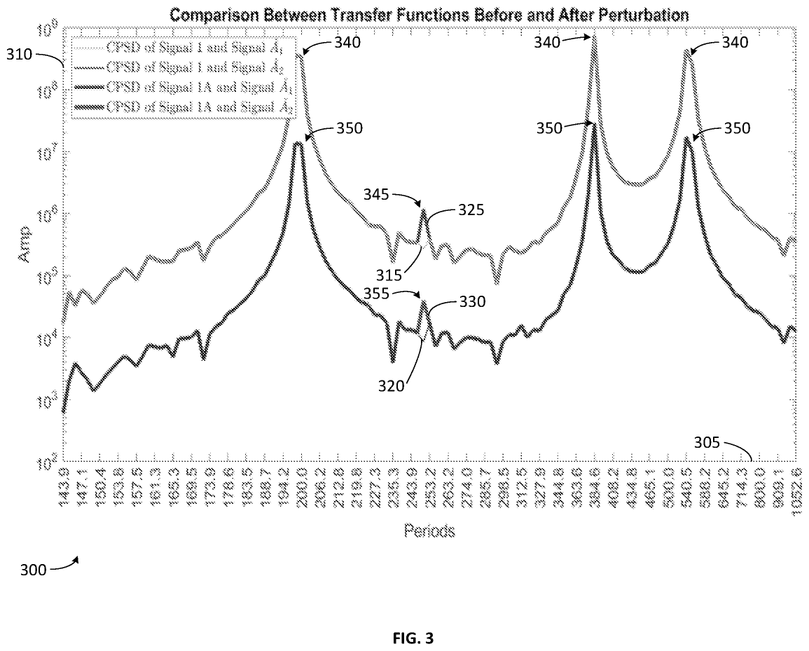

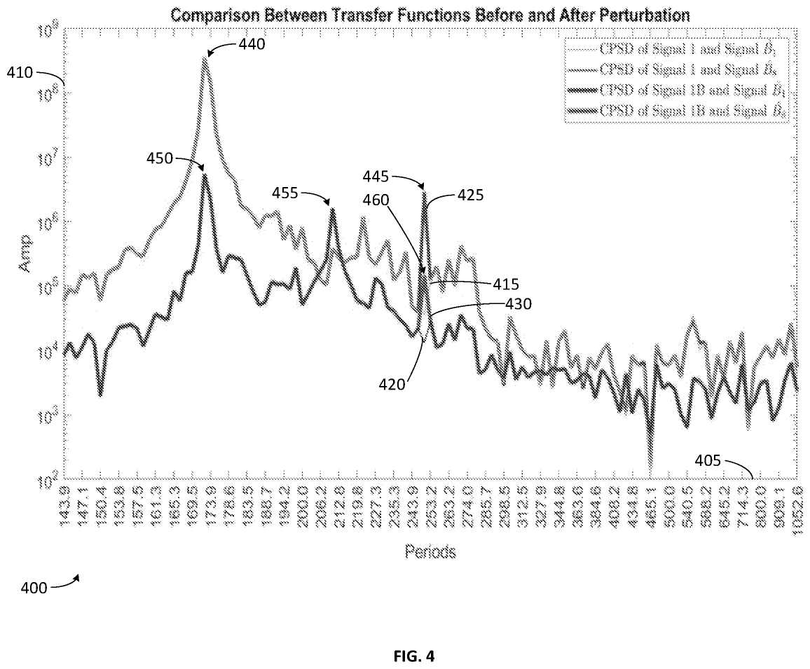

Further details regarding model dependency check system 105 are presented herein. In one embodiment, the operation of model dependency check system 105 will be described with reference to an example method 200 shown in FIG. 2. Further details on the operation of model dependency check system 105 are shown in the context of experimental validation of effectiveness and accuracy of operation of model dependency check system 105 shown in FIG. 3-FIG. 4.

### Example Method of ML Model Dependency Checking

FIG. 2 illustrates one embodiment of a dependency checking method 200 associated with dependency checking for ML models. At a high level, in one embodiment, dependency checking method 200 is a method for determining whether a repeating probe signal applied to a test signal input into an ML model transfers through into an estimate signal output from the ML model.

As an overview, dependency checking method 200 first applies an oscillating perturbation (one example of a repeating probe signal) to a test signal input into an ML model. Dependency checking method 200 then monitors the estimate signal(s) output from the ML model. Dependency checking method 200 checks the estimate signal(s) for the oscillating perturbation. Dependency checking method 200 then presents an evaluation of dependency in the ML model based at least in part on the results of the checking for the oscillating perturbation.

In one embodiment, dependency checking method 200 initiates at start block 205 in response to a processor of a computer configured to execute functions of model dependency check system 105 determining one or more of: (i) an ML model 110 evaluated by model dependency check system 105 has begun receiving test signals (e.g. 130); (ii) a user (or administrator) of model dependency check system 105 has initiated method 200; or (iii) that method 200 should commence in response to occurrence of some other condition. Method 200 continues to process block 210.

At process block 210, the processor applies an oscillating perturbation (or other repeating probe signal) to a test signal input into a machine learning model. In one embodiment, the test signal and the oscillating perturbation are time series signals. As used herein, the term “time series signal” refers to a data structure in which a series of data points (such as observations or sampled values) are indexed in time order. In one embodiment, the data points may be indexed with a time stamp or an observation number. In one embodiment, data points of a time series signal recur at a uniform or consistent interval. In one embodiment, a time series database of collection of signals is a data structure that includes one or more time-series signals sharing a series of time stamps or observation numbers in common.

As used herein, the term “test” as applied to time series signals refers to a portion of the observations in a time series database other than the portion used to train the machine learning model. In one example, a time series database used in ML prognostics may include signals collected or measured from sensors or other devices monitoring a system. Also, in one embodiment, the signals may be generated or synthesized by a signal generator to simulate signals collected from sensors or other devices, for example for experimentation or testing purposes. In either case, in one embodiment, the time series database is divided into multiple portions or segments of observations, including a training portion used to train or configure an ML model to accurately estimate values of the time series signals, and including a test portion used to examine the trained ML model for dependencies such as following or spillover. In one embodiment, a test signal refers to the portion of the observations of a signal that are used for testing. In one embodiment, the training and test portions do not overlap. In one embodiment, during method 200, the input signal provided to the ML model is a test signal of observations from the test portion of the time series database.

In one embodiment, the oscillating perturbation is a time series signal of the same length or number of observations as the test signal. In one embodiment, the oscillating perturbation is a pre-generated and retrieved from storage. In one embodiment, the oscillating perturbation is generated in response to the initiation of process block 210, for example as shown and described in further detail below.

In one embodiment, the oscillating perturbation is applied to the test signal by adding or summing the time series values at observations of the test signal and oscillating perturbation. In one embodiment, each pair of test signal value and oscillating perturbation value at corresponding indexes are added. The resulting value is the signal value for the test signal with the oscillating perturbation applied. For example, the first value of the test signal and the first value of the oscillating perturbation signal are added to produce a first value for the test signal with the oscillating perturbation applied, followed by similarly combining each subsequent pair of observation values in turn. Thus, each observation of the test signal is adjusted by the value of the oscillating perturbation at that observation. In this way, the oscillating perturbation may be overlaid on or embedded in the test signal.

In one embodiment, other methods of applying the oscillating perturbation to the test signal may be used. For example, the oscillating perturbation may be applied by subtracting the oscillating perturbation from the test signal, by multiplying the test signal by the oscillating perturbation, or by performing other mathematical operations that otherwise incorporate the oscillating perturbation into the test signal.

In one embodiment, once the oscillating perturbation has been applied to the test signal, the test signal with the oscillating perturbation applied is provided as an input to the machine learning model for monitoring by the machine learning model. Process block 210 then completes, and method 200 continues at process block 215. At the completion of process block 210, an oscillating perturbation that is used as a probe signal is applied to an input of the machine learning model. In one embodiment, this oscillating perturbation will appear in output estimates from the machine learning model where dependency (such as following or spillover) exists in the machine learning model.

At process block 215, the processor monitors an estimate signal output from the machine learning model. In one embodiment, the machine learning model accepts input of a time series database of test signals, and generates output of a time series database of estimate signals made up of estimated observation values of the test signals. In one embodiment, the time series databases have a number of observations m. In one embodiment, the machine learning model outputs a corresponding estimate signal for each test signal input into the ML model.

For example, in one embodiment, the machine learning model accepts test signals 1 through n as inputs, and generates estimate signals 1 through n as outputs. In one embodiment, each observation value x (where x is between 1 and m, inclusive) in the estimate signal is predicted or estimated based on corresponding observation values at x in other test signals. Thus, for example, the estimated value at a given observation x in estimate signal 1 may be based on the values at the given observation x in test signals 2 through n; the estimated value at observation x in estimate signal 2 may be based on the value at observation x in in test signals 1 and 3 through n; and so on.

In one embodiment, the input signals provided to the machine learning model include the input signal with oscillating perturbation applied. In a machine learning model that undesirably exhibits either following or spillover dependency, one or more of the estimate signals output from the model may include the oscillating perturbation.

In one embodiment, to monitor estimate signals output from the machine learning model the processor collects the output estimate observation values for the estimate signals, and stores them, for subsequent processing. In one embodiment, an estimated or predicted observation value is produced by the ML model for each observation value 1 though m. In one embodiment, the sequence of observation values predicted by the ML model are appended as observation values to an estimate time series signal of m observations. In one embodiment, estimate signals are produced for several test signals. In one embodiment, each of the estimate signals produced are stored, for example as a time series database or other data structures.

Process block 215 then completes, and method 200 continues at process block 220. At the completion of process block 215, a test signal including an oscillating perturbation as a probe signal has been input into a trained machine learning model. The machine learning model has executed to generate and output an estimate signal. Where the machine learning model has been trained in a way that causes the model to include following or spillover dependencies, the estimate signal includes the oscillating perturbation to some extent. Where the machine learning model includes dependencies and produces multiple estimate signals, one or more of the estimate signals include the oscillating perturbation to some extent. The monitoring captures the estimate signal(s) for subsequent analysis to check for and detect the presence of the oscillating perturbation (or other repeating probe signal).

At process block 220, the processor checks for the oscillating perturbation (or other repeating probe signal) in the estimate signal. Where the oscillating perturbation appears to a non-zero extent in the estimate signal, the trained ML model exhibits dependency. As discussed below, where the estimate signal in which the oscillating perturbation appears is an estimate signal that predicts values for the test signal with the oscillating perturbation applied, the dependency in the ML model is a following-type dependency. And, where the estimate signal in which the oscillating perturbation appears is an estimate signal that predicts values for a different test signal that does not have the oscillating perturbation applied, the dependency in the ML model is a spillover-type dependency.

In one embodiment, to check for the presence of the oscillating perturbation in the estimate signal, the processor performs a bivariate cross power spectral density (CPSD) calculation between the test signal with the oscillating perturbation applied and the estimate signal. The CPSD serves as a transfer function between the test and estimate signals. Where the oscillating perturbation appears in the estimate signal as well as the test signal, a well-defined peak will appear in the CPSD at the frequency of the oscillating perturbation. The presence of this peak may be detected by comparing two CPSDs: the CPSD between the test signal and estimate with the oscillating perturbation applied to the test signal and the CPSD between the test signal and estimate without the oscillating perturbation applied to the test signal.

In one embodiment, if applying the oscillating perturbation to the test signal makes little or no difference in CPSD amplitude at the frequency (or period) of the oscillating perturbation, the oscillating perturbation is not present in the estimate signal. In one embodiment, if applying the oscillating to the test signal causes the CPSD amplitude at the frequency (or period) of the oscillating perturbation to differ, the oscillating perturbation is present in the estimate signal.

In one embodiment, the boundary between presence or absence of the oscillating perturbation in the estimate signal may be expressed by a threshold. In one embodiment, the threshold, where satisfying the threshold indicates that the oscillating perturbation is sufficiently present in the estimate signal. In one embodiment, the threshold may be a pre-determined value of a coupling metric between the test signal and estimate signal. In one embodiment, the threshold may be a pre-determined value of a ratio of CPSD amplitudes (at the frequency of the perturbation) of the signals after and before the perturbation was introduced. In one embodiment, the threshold may be a pre-determined value of a severity metric.

In one embodiment, the oscillating perturbation may thus be checked for in output estimates of the machine learning model to determine if dependency (such as following or spillover) exists in the machine learning model. Where the oscillating perturbation can be detected in one or more of the output estimates, dependency exists in the machine learning model. Further details on checking for the presence of the oscillating perturbation in the estimate signal are described elsewhere herein.

Process block 220 then completes, and method 200 continues at process block 225. At the completion of process block 220, the processor has inferred a transfer function between the test signal and the estimate signal. The transfer function indicates (for example, by well-defined peaks in a CPSD) where the test signal and estimate signal both have content at similar periods or frequencies. Where superimposing the oscillating perturbation (or other repeating probe signal) onto the test signal causes a substantial peak in the CPSD at the frequency of the oscillating perturbation, a dependency phenomenon is occurring that causes the oscillating perturbation to appear, to a greater or lesser extent, in the estimate signal. Thus, the processor checks for the appearance of the oscillating perturbation in the estimate as an indication of the presence of a dependency phenomenon (following or spillover).

At process block 225, based on the results of the checking for the oscillating perturbation the processor presents an evaluation of dependency of the machine learning model. In one embodiment, the evaluation of dependency is a data structure containing information about the nature and extent of dependency in the ML model. In one embodiment, the evaluation of dependency includes one or more of a transfer function between the test signal and the estimate signal, a coupling coefficient that quantifies an extent to which the test signal influences the estimate signal, a perturbation change ratio that shows the change in magnitude of the transfer function due to application of the oscillating perturbation, and a severity metric that quantifies an extent to which a dependency detrimentally influences accuracy of ML predictions. In one embodiment, the evaluation of dependency may include transfer functions, coupling coefficients, perturbation change ratios, and severity metrics for multiple test signal—estimate signal pairs in the ML. For example, the evaluation of dependency may include such features for each pairing of input and output in the ML model.

In one embodiment, the data generated during the steps of method 200 is stored in or transferred to the evaluation of dependency. In one embodiment, presenting the evaluation of dependency includes making the evaluation of dependency or one or more of its contents accessible through an application programming interface (API), such as a representational state transfer (REST) API. In one embodiment, presenting the evaluation of dependency includes generating a graphical user interface (GUI) including one or more of the contents of the evaluation of dependency, and transmitting the GUI for display by a computing device.

In one embodiment, the evaluation of dependency may indicate that an ML model includes an unacceptably severe dependency, and recommend retraining or redevelopment of the ML model. Process block 225 then completes, and method 200 continues to END block 235, where method 300 completes.

As discussed in detail herein, the presence of following may cause ML models to miss triggering an alarm for a legitimate degradation signal, and the presence of spillover may cause ML models to trigger alerts on signals where no degradation is occurring. In one embodiment, the dependency checking systems and methods described herein reveal these hidden following and spillover dependencies within the ML model. And, in one embodiment, the discovered following and spillover dependencies may be quantified as to the severity of their effect on the accuracy of the ML model estimates. The ML model may therefore be improved or replaced in accordance with the results of the dependency checking. In one embodiment, the system may automatically act to mitigate discovered dependencies, thereby strengthening the ML model.

In one embodiment, as discussed in further detail herein, the checking for the oscillating perturbation (or other repeating probe signal) also includes the processor performing a cross power spectral density transform on the test signal and the estimate signal. The processor then examines the cross power spectral density at a frequency of the oscillating perturbation to determine whether a peak is present or absent at the frequency. In response to determining that the peak is present at the frequency in the cross power spectral density, the processor indicates that the machine learning model inaccurately predicts the estimate signal in the evaluation of dependency. The model may inaccurately predict the estimate signal due to a dependency indicated by the presence of the peak at the frequency of the oscillating perturbation. In response to determining that the peak is absent (not present) at the frequency in the cross power spectral density, the processor indicates that the machine learning model accurately predicts the estimate signal in the evaluation of dependency. Assuming no other dependencies from other input signals, the model should accurately predict the estimate signal because the lack of a peak at the frequency of the oscillating perturbation.

In one embodiment, as discussed in further detail herein, the processor infers a coupling coefficient between the test signal and the estimate signal based on the oscillating perturbation (or other repeating probe signal). The coupling coefficient quantifies the extent to which the oscillating perturbation transfers through from the test signal to the estimate signal. In one embodiment, the coupling coefficient is inferred by measurement. For example, the processor may perform Fourier transforms on the test signal and the estimate signal to find power spectral density (PSD) functions that represent the test signal and the estimate signal in the frequency domain. The amplitude at the frequency of the oscillating perturbation is measured in the PSD for the test signal (referred to as input amplitude). The amplitude at the frequency of the oscillating perturbation is also measured in the PSD for the estimate signal (referred to as output amplitude). In one embodiment, the coupling coefficient is the ratio of the output amplitude to the input amplitude. In one embodiment, once the coupling coefficient is inferred, the processor may then present the coupling coefficient in the evaluation of dependency.

In one embodiment, as discussed in further detail herein, the oscillating perturbation (or other repeating probe signal) is sinusoidal. For example, the processor may further generate the oscillating perturbation as a sinusoidal waveform.

In one embodiment, as discussed in further detail herein, the processor automatically selects an amplitude of the oscillating perturbation (or other repeating probe signal) that is within a noise band of the test signal. From that selected amplitude, the processor then generates the oscillating perturbation to have the amplitude. In one embodiment, the oscillating perturbation (or other repeating probe signal) is generated by concatenating and linking together time series for one or a few periods or cycles of the perturbation into the oscillating signal for the length or number of observations of the test signal. In one embodiment, the noise band of the test signal is a standard deviation or variance about the average value of the test signal. In one embodiment, the processor calculates the standard deviation of the average value of the test signal, and then selects an amplitude for the oscillating perturbation that is less than the standard deviation. The processor then generates the oscillating perturbation to have the selected amplitude.

In one embodiment, as discussed in further detail herein, the estimate signal predicts values for a second test signal that is input into the machine learning model. The processor then determines that the estimate signal erroneously predicts values for the second test signal that at least partially mimic the behavior of the test signal. The processor then indicates that the machine learning model is subject to spillover in the evaluation of the dependency of the machine learning model. Spillover is a form of dependency that may be exhibited by ML models. Spillover occurs where an ML estimate for one signal input to an ML model emulates behavior of another signal input to the ML model such that the ML estimate erroneously predicts values for the one signal that partially or wholly mimic the behavior of the other signal.

In one embodiment, as discussed in further detail herein, the estimate signal predicts values for the test signal that has the oscillating perturbation (or other repeating probe signal) applied to it. The processor then determines that the estimate signal erroneously predicts values that at least partially mimic the behavior of the test signal. The processor then indicates that the machine learning model is subject to following in the evaluation of the dependency of the machine learning model. Following is a form of dependency that may be exhibited by ML models. Following occurs where an ML estimate for a signal emulates the behavior of the signal such that the ML estimate erroneously predicts values that partially or wholly mimic the behavior of the signal.

In one embodiment, as discussed in further detail herein, where the repeating probe signal appears in the estimate signal, the processor determines a severity metric between the test signal and the estimate signal. As discussed herein, the severity metric quantifies an extent to which dependency adversely affects accuracy of the estimate signal. The processor evaluates the severity metric to determine that a mitigation technique should be applied to the ML model. In one embodiment, the evaluation includes comparing the value of the severity metric to a threshold that indicates that a mitigation technique should be employed. The processor then automatically implements that mitigation technique. In one embodiment, where a dependency is discovered between the input signal and the output signal, the system may include in the evaluation of dependency one or more of mitigation techniques to reduce the dependency, such as: increasing a number of training vectors used to train the ML model, performing filtering operations on the training signals and monitored signals to reduce noise, and changing the number of monitored signals. In one embodiment, the processor may automatically implement one or more of the mitigation techniques in response to the discovery of the dependency. In one embodiment, as discussed elsewhere herein, the processor may generate a severity metric quantifying the extent to which the dependency adversely affects the output estimate by the ML model. In one embodiment, the processor may automatically implement a mitigation technique in response to a severity metric satisfying a threshold that indicates that the mitigation technique should be employed. In one embodiment, the automatic implementation includes presenting a user-selectable option in a GUI as to whether or not to proceed with implementing the mitigation technique, accepting an input selecting whether to proceed or not to proceed, and automatically performing the mitigation technique, or not, in response to the selection.

In one embodiment, while the model dependency check systems and methods described herein are described with respect to use of an oscillating perturbation as the repeating probe signal, other repeating probe signals may also be used. In one embodiment, the repeating probe signal forms a consistent pattern of signal values that recurs at uniform intervals. The uniform interval at which the pattern of the probe signal repeats may be referred to herein as a period of the repeating probe signal. The inverse of the period of the repeating probe signal is the frequency of the repeating probe signal (frequency=1/period). Thus, in one embodiment, the repeating probe signal is the oscillating perturbation: a repeating probe signal with signal values that oscillate or vary in magnitude in a repeating manner about a central value. In one embodiment, the repeating probe signal is a sinusoid pattern or curve having values in the form of a sine wave.

In one embodiment, the repeating probe signal is a pulse pattern in which the signal values alternate between a minimum and maximum value at a steady frequency. For example, the pulse pattern may be a square wave, in which the signal values spend the same duration at maximum and minimum. Or, for example, the pulse pattern may be a rectangular wave, in which the signal values form an asymmetrical pulse pattern where the signal values spend different durations at maximum and minimum. In one embodiment, the repeating probe signal is a triangle waveform in which the signal values alternately ramp linearly upwards and downward between a minimum and maximum value over a period of time. In one embodiment, the repeating probe signal is a sawtooth waveform in which the signal values ramp linearly between a minimum and maximum and sharply return to the minimum (or the inverse) over a period of time. In one embodiment, the repeating probe signal is another waveform that recurs over a period of time. In one embodiment, the repeating probe signal is a compound pattern made up of more than one constituent pattern of signal values.

### ML Modeling

ML modeling may be used as a technique for discovering the onset of anomalies in complex engineering systems in many fields that use sensors to monitor processes. This anomaly discovery may also be referred to as prescriptive or prognostic anomaly detection. For example, such modeling finds application in fields as diverse as utilities, oil & gas production and refining, aviation, datacenter information technology, military vehicles and installations, and other sectors in which sensors (such as Internet of things (IOT) sensors) are used to monitor activity. In particular, multivariate ML modeling can be used for prescriptive or prognostic anomaly detection. ML-based anomaly detection may be performed, for example, in large-scale time series databases, or for example, for real-time streaming prognostics.

In general, the ML modeling techniques used for anomaly detection predict or estimate what each signal should be or is expected to be based on the other signals in the database. The predicted signal may be referred to as the “estimate”. For example, for Signal 1 in a database of N signals, the ML model will compute an estimate for Signal 1 using signals 2 through N. In a “good” or accurate ML model, the signals and their estimates overlay well.

Subtracting each signal from its corresponding estimate gives the residuals or differences between the values of the signal and estimate. Where there is an anomaly in a signal, the measured signal departs from the estimated signal. This causes the residuals to increase, triggering an anomaly alarm. Thus, the residuals are used to detect such anomalies where one or more of the residuals indicates such a departure, for example by becoming consistently excessively large. For example, the presence of an anomaly may be indicated by a sequential probability ratio test (SPRT) analysis of the residuals.

ML modeling may be subject to two different types of dependency phenomena called following and spillover. These phenomena can cause excessive False-Alarm Probabilities (FAPs) and Missed-Alarm Probabilities (MAPs) in multivariate ML anomaly detection.

In one embodiment, the dependency checking systems and methods described herein implement a novel approach for characterizing ML model robustness with regard to following and spillover. In one embodiment, the dependency checking systems and methods described herein apply a bivariate Fourier transform technique called cross-power-spectral-density (CPSD, as defined and illustrated below) to identify and characterize following and spillover phenomena in ML models. In one embodiment, a dynamic sinusoidal probe signal is applied to one or more variables or signals in time series input to an ML model, and by application of the CPSD technique discover and quantify following and spillover phenomena.

Advantageously, the dependency checking systems and methods described herein discover and quantify following and spillover phenomena with higher accuracy and lower compute cost than is possible using existing techniques. In one embodiment, the dependency checking systems and methods described herein enable an autonomous robustness check for the presence and extent of following and spillover dependencies in an ML model prior to ML anomaly detection analysis of any database of telemetry signals. In one embodiment, the autonomous dependency checking enabled by the dependency checking systems and methods described herein significantly reduce costly FAPs, and significantly reduce potentially catastrophic MAPs.

All types of multivariate ML models may be susceptible to following or spillover phenomena, presenting a challenge to the prognostic accuracy of ML modeling. Following and spillover phenomena manifest in an ML model depending in a complex nonlinear way on factors such as number of signals being monitored, degree of correlation between or among the monitored signals, and noise ratio (a measure of random noise component of the raw sensor outputs) on individual monitored signals.

In one embodiment, the dependency checking systems and methods described herein introduce a small sinusoidal perturbation to a measured or test signal input into a ML model. The dependency checking systems and methods described herein then perform a bivariate cross-power-spectral-density (CPSD) computation between the input test signal and an output estimated signal to derive a transfer function between the input and the output. From that transfer function, the dependency checking systems and methods described herein may infer a coupling coefficient that measures how efficiently the perturbation transfers across the ML model from the input test signal to the output estimated signal.

As mentioned above, following occurs where an ML estimate for a signal emulates the behavior of the signal such that the ML estimate erroneously predicts values that partially or wholly mimic the behavior of the signal. In other words, where degradation appears in the signal, the ML model estimate will “follow” the degradation in the signal, incorrectly predicting values that mimic the degradation to a greater or lesser extent. When the model estimates follow the degradation signature, then the residuals remain small. The residual may therefore not get large enough to trigger an anomaly alarm, and no degradation is detected. This is an undesirable and potentially dangerous quality. Models susceptible to following may thus have high Missed Alarm Probabilities (MAPs). The missed alarms due to following may cause catastrophic failure of a monitored system. Further, the missed alarms caused by following may be dangerous in safety-critical industries, and costly in industries for which undetected anomalies can lead to catastrophic failures. Following may be caused in an ML model by generating the ML model from a multivariate set of signals that have very little correlation, a low signal to noise ratio, and/or a small number of signals in the model.

As mentioned above, spillover occurs where an ML estimate for one signal input to an ML model emulates behavior of another signal input to the ML model such that the ML estimate erroneously predicts values for the one signal that partially or wholly mimic the behavior of the other signal. In other words, where degradation appears in one signal, the degradation can influence the behavior of or “spill over” into estimates for other signals that do not include the degradation. Real degradation appearing in one signal can cause alarms to be triggered for other signals that contain no anomalies. Models susceptible to spillover will have high False Alarm Probabilities (FAPs). The false alarms caused by spillover can lead to unnecessary and wasteful service actions to fix components or subsystems of monitored systems that are not experiencing any degradation. The false alarms caused by spillover can also lead to confusion for human-in-the-loop supervisory control of monitored systems. For example, false alarms due to spillover can lead to confused identification of source of degradation anomalies in the monitored system.

Referring again to FIG. 1, model dependency check system 105 implements a novel approach for detection and characterization of following and spillover. In one embodiment, ML model 110 is a nonlinear, nonparametric ML model. In one embodiment, the ML model 110 infers the monitored system states from the inputs to produce the estimate signals. In one embodiment, the estimate signals 115, 120, 125 are the result of a function S of test signals 130, 135, 140 (U) to which the oscillating perturbation d 145 is applied.

In one embodiment, the test signals 130, 135, 140 (U₁-Uₙ) are example test signal inputs of telemetry signals that represent workload or operational status of an example monitored system. In one embodiment, test signals 130, 135, 140 inputs may include performance metrics typical user workload transactions in a computing system. Such performance metrics may include loads, throughput, queue lengths, transaction latencies, and other metrics describing operational state of a computing system. In one embodiment, test signals 130, 135, 140 may include measurements of physical phenomena occurring in or around a system or device. Such physical phenomena may include such as voltages, currents, temperature, vibration, and other phenomena detectable by sensors. In one embodiment, the estimate signal 115, 120, 125 (Y₁-Yₙ) outputs are predictions of behavior of the example monitored system. In one embodiment, estimate signal 115, 120, 125 outputs may include estimates of the compute system performance metrics or of the physical phenomena mentioned above.

To characterize and then counteract following and spillover, in one embodiment, the model dependency check system 105 may be configured to determine a transfer function between input signals and output estimate signals. The transfer function is a mathematical representation of how the ML model (such as ML model 110) changes the inputs to obtain the outputs. In one embodiment, the transfer function assumes a direct (that is, not inverse) relationship between inputs and outputs.

In one embodiment, estimate checker 155 infers transfer functions between an input test signal U₁ 130 with an oscillating perturbation d 145 applied and one or more of estimate signals 115, 120, 125 (Y₁-Yₙ). In one embodiment, the transfer function is inferred by performing a bivariate spectral decomposition of the input test input test signal U₁ 130 with the oscillating perturbation d 145 applied and the estimate signal. In one embodiment, the bivariate spectral decomposition technique is a cross power spectral density (CPSD) algorithm. In one embodiment, the system may check for presence of the oscillating function in the output estimate signals using the transfer function.

In one embodiment, the probe signal, disturbance, or oscillating perturbation d 145 is a mono-frequency sinusoidal signal. In one embodiment, oscillating perturbation d 145 is a multi-frequency sinusoidal signal. In one embodiment, a mono-frequency probe signal may be preferable because, in subsequent analysis with the CPSD, a mono-frequency probe signal produces a single prominent spike in the frequency domain. In CPSD analysis with a multi-frequency probe signal produces multiple frequency domain spikes corresponding to the component frequencies of the multi-frequency probe signal. The frequency domain spike (or spikes) may be used as a robust and accurate probe for assessing the coupling coefficient for propagation from ML model inputs to ML model outputs.

In one embodiment, use of the CPSD between an ML model input (point A) and an ML model output (point B) for inferring the transfer function between points A and B has an advantageous property: the CPSD ignores or minimizes signal components that may affect point A and point B separately (such as random incoherent noise), and is sensitive to the correlated vibration that is seen at both points A and B. The spikes in the frequency domain from the probe signal at points A and B are amplified by the CPSD. Any periodic content that does not have any overlap will result in much smaller amplitudes in the CPSD.

The combination of the fact that CPSD amplifies frequencies that appear at both points A and B with the fact that mono-frequency input translates into a single spike in the frequency domain enables generation of the transfer function even through a complex ML model, and even where the signals have a high level of superimposed noise. In one embodiment, the process for finding the transfer function includes taking the Fourier transform of the input and the output, multiplying them in the frequency domain, and comparing the amplitude of the peaks.

In one embodiment, the ML model is an MSET model, the measurements or test signals are treated as the inputs, and the ML model estimates as the output. In one embodiment, to quantify following and spillover in the ML model a perturbation (such as oscillating perturbation d 145) is placed on the testing portion of the data. In one embodiment, the sinusoidal perturbation is artificially generated to have known, pre-determined characteristics of amplitude, period, and waveform. In one embodiment, the perturbation is small in amplitude relative to the amplitude of the test signal input to which the perturbation is applied. In one embodiment, the perturbation is small in period so as to be able to repeat within and not go outside of the training range of the input signal. Thus, in one embodiment, the perturbation (such as oscillating perturbation d 145) used as a probe signal is small relative to the signal input to which it is applied. In one embodiment, the perturbation is periodic or repeating in nature so as to be clearly identifiable in the frequency domain. In one embodiment, the perturbation is sinusoidal, such as a mono-frequency pure sine wave.

As previously mentioned, following occurs when the estimates by an ML algorithm for an input signal are influenced by anomalous behavior in the input signal and begin to mimic the anomalous patterns. For example, where a ramp of steadily increasing values is inserted into a signal input to an ML model that is subject to following, estimates for the signal “follow” the ramp. Similarly, where the small sinusoidal perturbation is inserted into a signal, when following occurs in the ML model, the ML model's estimates for the signal will mimic the small sinusoidal perturbation. Therefore, when the transfer function is found between the testing portion and the estimates, the severity of the following can be quantified by calculating the magnitude of the perturbation frequency in the CPSD. Likewise, spillover can be assessed by comparing the testing potion of signal with a perturbation to the estimates of other signals that do not contain the extra sinusoidal content.

In one embodiment, CPSD between input and output signals provides a transfer function identifies the presence (or absence) of following or spillover in an ML model. A coupling coefficient that quantifies the extent of the following or spillover may be inferred using the CPSD transfer function. In one embodiment, the coupling coefficient may be inferred from comparison of the CPSD of the input and output signals without the perturbation applied to the input and with the perturbation applied to the input. For example, the ratio of CPSD amplitudes at the frequency of the perturbation may be calculated and used as the coupling coefficient. Thus, in one embodiment, the coupling coefficient between an input and an output is inferred by generating a CPSD between the input and the output before adding an oscillating perturbation to the input, generating a CPSD between the input and the output after adding the oscillating perturbation to the input, and finding the ration between the CPSD amplitudes at a frequency at which the oscillating perturbation oscillates.

### Example Transfer Function Analysis of Dependency-Free ML Models

FIG. 3 illustrates a plot 300 of results of a transfer function analysis for a first example signal database of time series data. The transfer function analysis is associated with dependency checking for machine learning (ML) models. In order to provide a baseline, the first example signal database includes signals such that a model trained on the signals will not exhibit following or spillover. The first example signal database includes twenty example time series signals, including Signal 1 and Signal 2. Plot 300 shows CPSD between Signals 1, before and after a sine wave perturbation is applied, and ML model (such as MSET) estimates for Signal 1 and Signal 2 for the first example signal database.

In this example, the example time series signals of the first example signal database are highly correlated (in this case, having a minimum cross correlation value among signals in excess of 0.95). The example time series signals have 40,000 data points or observations at a sampling rate of one sample per second. The time series signals exhibit three separate seasonality modes. The periodicities for the three seasonality modes (expressed in number of observations) are 199, 383, and 547.

In this example, an example ML model is trained on a training range or portion (such as the first 50%) of the first example signal database. The trained example ML model may then surveil or monitor a test range or portion (such as the second 50%) of the first example signal database to produce estimate signals Â. As discussed above, a transfer function between an input to an ML model and an output from the ML model may be found by taking the CPSD between the input and output signals.

Plot 300 shows several CPSD curves plotted against a period axis 305 and a logarithmic amplitude axis 310. First CPSD 315 is a CPSD between a Signal 1 (without perturbation) and an ML model estimate for Signal 1, Signal Â₁. Second CPSD 320 is a CPSD between Signal 1 and an ML model estimate for Signal 2, Signal Â₂. In one embodiment, a perturbation is applied as a probe signal to Signal 1, forming Signal 1A. In one embodiment, the applied perturbation is a pure sine wave with a period of 250. Third CPSD 325 is a CPSD between Signal 1A, and an ML model estimate for Signal 1, Signal Â₁. Fourth CPSD 330 is a CPSD between Signal 1A and an ML model estimate for Signal 2, Signal Â₂.

As an example, ML models trained on first example database exhibit little to no following or spillover due to strong signal correlation. In one embodiment, this may be verified by transfer function analysis. For example, the sine wave perturbation with a period of 250 is applied to the testing range of Signal 1. An MSET ML model is then trained on the first half (the training range) of the first example signal database. MSET estimates are generated by the trained MSET model for the second half (the testing range) of the first example signal database. After the MSET estimates are generated, the transfer function analysis between Signal 1 and the MSET estimates for Signal 1 (Signal Â₁) and the MSET estimates for Signal 2 (Signal Â₂) is performed to produce the results shown in plot 300. Plot 300 thus presents results of the transfer function analysis for the first example signal database.

As a point of reference, the CPSDs for the signals are computed before and after the perturbation. When the first CPSD 315 between Signal 1 and its estimate Signal Â₁ is calculated, it is apparent that the known periods of 199, 383, and 547 for the three separate seasonality modes appear with well-defined peaks 340 in first CPSD 315. This is a direct consequence of the coupling effect. Both Signal 1A and the MSET estimate Signal Â₁ contain the same periodic information and therefore the periods that both signals have in common are amplified.

When comparing first CPSD 315 to third CPSD 325 (the CPSD between Signal 1A and the MSET estimate Signal Â₁) it is apparent that there is a new peak 345 at period 250. The new peak 345 at period 250 is a result of the added perturbation in signal 1A. But the periodic content added by the perturbation oscillating with a period of 250 is decades smaller than the more dominant periodic content. The periodic content of the perturbation at period 250 in Signal 1A is not amplified in the third CPSD 315 due to the lack of periodic content at period 250 in the estimate Signal Â₁. The amplitude of the sine wave at period 250 thus does not receive any multiplicative effect from the third CPSD. The system may therefore conclude that following is not present in the MSET model trained on the first example signal database. The system may so conclude because the new peak 345 is small relative to the peaks 340 of the periodic components of the signals. Following is therefore minimal or non-existent, and may be considered to be absent from this MSET model.

Were following present, both Signal 1A the estimate Signal Â₁ would contain a sine wave with a period of 250, which would be amplified by the CPSD. Thus, were following present, the new peak 345 in third CPSD at period 250 would display a coupling effect and the amplitude of the new peak 345 would be a factor of 10× to 100× larger.

Similarly, by comparing the second CPSD 320 (the CPSD between Signal 1 and the MSET estimate Signal Â₂) and fourth CPSD 330 (the CPSD between Signal 1A and the MSET estimate and the MSET estimate Signal Â₂), the system can also conclude that no spillover occurs. As above, the periods for the three separate seasonality modes appear with well-defined peaks 350 in second CPSD 320. These peaks are amplified by the periodic content of the seasonality modes appearing in both Signal 1 and the MSET estimate Signal Â₂. A new peak 355 appears at period 250 in fourth CPSD 330 due to the added perturbation in Signal 1A. As in the analysis for following above, the periodic content at period 250 in Signal 1A is substantially canceled out in the fourth CPSD 330 by the lack of periodic content at period 250 in MSET estimate Signal Â₂. The system may therefore conclude that spillover is not present in the ML (e.g. MSET) model trained on the first example database because the new peak 355 is small relative to the peaks 350 of the periodic components of the signals. If spillover were present, MSET estimate Signal Â₂ would contain the periodic content from the perturbation on Signal 1A and amplify the new peak 355 at period 250.

The example ML model trained on the first example database is therefore found to be free of the following and spillover dependencies.

### Example Transfer Function Analysis of Dependency-Prone ML Models

FIG. 4 illustrates a plot 400 of results of a transfer function analysis for a second example signal database of time series data. The transfer function analysis is associated with dependency checking for machine learning (ML) models. In order to provide a contrast, the second example signal database includes signals such that a model trained on the signals will exhibit following and spillover. The second example signal database includes twenty example time series signals, including Signal 1 and Signal 8. Plot 400 shows CPSD between Signal 1, before and after a sine wave perturbation is applied, and ML model (such as MSET) estimates for Signal 1 and Signal 8 for the second example signal database.

In this example, the example time series signals of the second example signal database are weakly correlated (in this case, having a maximum cross correlation value among signals below of 0.05). As above, the example time series signals have 40,000 data points or observations at a sampling rate of one sample per second. The time series signals each have different periodicity. For example, they may have periods of prime numbers between the values of 173 and 277. Periods of 20 prime values in close proximity eliminates harmonics between signals and ensures the low cross correlation in the second example signal database. These features of the second example signal database are chosen to increase the propensity for following and spillover in order to provide behavior that contrasts with the first example signal database discussed above with reference to FIG. 3. ML models trained on the second example signal database are therefore susceptible to a high degree of following due to the weak correlation between signals.

An example ML model is trained on a training range or portion (such as the first 50%) of the second example signal database. The trained example ML model may surveil or monitor a test range or portion (such as the second 50%) of the second example signal database to produce estimate signals \hat{B}. Transfer functions between input and output points may be found by taking the CPSD between the input and output signals.

Plot 400 shows several CPSD curves plotted against a period axis 405 and a logarithmic amplitude axis 410. First CPSD 415 is a CPSD between a Signal 1 (without perturbation) and an ML model estimate for Signal 1, Signal \hat{B}₁. Second CPSD 420 is a CPSD between Signal 1 and an ML model estimate for Signal 8, Signal \hat{B}₈. In one embodiment, as above, the sine wave perturbation with a period of 250 is applied as a probe signal to Signal 1, forming Signal 1B. Third CPSD 425 is a CPSD between Signal 1B, and an ML model estimate for Signal 1, Signal \hat{B}₁.

Fourth CPSD 430 is a CPSD between Signal 1B and an ML model estimate for Signal 8, Signal \hat{B}₈.

Transfer function analysis of ML models trained using the second example signal database illustrates how, in one embodiment, the model dependency check systems and methods described herein characterize following and spillover. As an example, ML models trained on the second example database exhibit following and spillover due to lack of signal correlation. In one embodiment, the following and spillover may be characterized by transfer function analysis. For example, as above, a sine wave perturbation with a period of 250 is applied to the testing range of Signal 1. An MSET ML model is then trained on the first half (the training range) of the second example signal database. MSET estimates are generated for the second half (the testing range) of the second example signal database. After the MSET estimates are generated, the transfer function analysis between Signal 1 and the MSET estimates for Signal 1 (Signal \hat{B}₁) and the MSET estimates for Signal 8 (Signal \hat{B}₈) is performed to produce the results shown in plot 400. Plot 400 thus presents results of the transfer function analysis for the second example signal database.

When first CPSD 415 between Signal 1 and its estimate Signal \hat{B}₁ is calculated, it is apparent that there is a well-defined peak 440 at period 173, the period of Signal 1. Now comparing first CPSD 415 to third CPSD 425 between Signal 1B and the MSET estimates for Signal 1 (Signal \hat{B}₁), it is apparent that there is a new peak 445 at period 250. In contrast to the CPSDs of plot 300 for first example signal database shown and described with reference to FIG. 3, the new peak 445 at period 250 is much higher in amplitude and more commensurate with the amplitude of dominant frequency of 173. Because both Signal 1 the MSET estimate Signal \hat{B}₁ contain a sine wave with a period of 250, there is a substantial scaling effect in the CPSD at period 250 that indicates a significant coupling effect. The system may therefore conclude that following is indeed present in the MSET model trained on the second example signal database.

Similarly, comparing the second CPSD 420 (the CPSD between Signal 1 and the MSET estimates for Signal 8, Signal \hat{B}₈)with the fourth CPSD 430 (the CPSD between Signal 1B and the MSET estimate Signal \hat{B}₈) reveals that spillover is also occurring in the MSET model trained on the second example signal database. In second CPSD 420, a first peak 450 appears at period 173, the period of Signal 1, and a second peak 455 appears at period 211, the period of Signal 8. These peaks 450, 455 are not amplified in the CPSD because the periodic content of Signal 1 at period 173 does not appear in Signal 8, and the periodic content of Signal 8 at period 211 does not appear in Signal 1. A new peak 460 appears at period 250 in fourth CPSD 430 due to the added perturbation in Signal 1B. Both Signal 1B the estimate Signal \hat{B}₈ contain a sine wave with a period of 250. The amplification of the sine wave by the fourth CPSD 430 to form new peak 460 reveals the coupling between Signal 1B the estimate Signal \hat{B}₈. The small amplitude of the sine wave perturbation is multiplied by the fourth CPSD to form substantial new peak 460 that approaches the amplitude of the periodic content of Signals 1 and 8. The system may therefore conclude that spillover is present in the ML (e.g. MSET) model trained on the second example database because the new peak 460 is not small relative to the peaks 450, 455 of the periodic components of the signals. In particular, the system may conclude that spillover is present between Signal 1 and the estimate for Signal 8, Signal \hat{B}₈.

ML models trained on databases of signals having high noise content or having few signals may also be susceptible to a high degree of following and/or spillover. In one embodiment, performing the transfer function analyses discussed herein similarly reveals and characterizes following and spillover in models trained on databases of signals having high noise content or few signals. In one embodiment, the transfer function analyses discussed herein successfully reveal and characterize following and spillover in ML models trained on databases of signals that are pure Gaussian noise.

### Coupling Coefficient and Severity Metrics

In one embodiment, once the transfer function analyses have detected dependency (following or spillover) between an input and an output in an ML model, a coupling coefficient may be inferred from the input and output. The coupling coefficient quantifies extent of the coupling, or influence that the input has on the output. In one embodiment, the coupling coefficient may be defined as the ratio of the amplitude (peak height) for the output signal at the frequency of the oscillating perturbation to the amplitude (peak height) of the oscillating perturbation. These peak heights may be determined by performing Fourier transforms on the output time series signal and the perturbation time series signal to place them into the frequency domain, and then identifying the peak height at the frequency of the oscillating perturbation. For example, where a sinusoid with a frequency of 1 Hz and an amplitude of 1 is applied to an input of an ML model, and there is a small peak with an amplitude of 0.1 in the frequency domain at 1 Hz for an output of the ML model, then the coupling coefficient between the input and output is 0.1. Where there is no peak in the output at the frequency of the perturbation, there is zero coupling between the input and output. For coupling between an input perturbation and an output signal that has no gain (or amplification) and no loss (or attenuation), the coupling coefficient is 1.0. Coupling coefficients greater than 1.0 indicate gain or amplification of the following or spillover phenomena.

In one embodiment, the coupling coefficient metrics are calibrated to the degree of following and spillover to produce a severity metric. In one embodiment, the severity metric is provided to quantitatively assess the extent to which following or spillover in an ML model adversely influences accuracy of an estimate. In one embodiment, a ratio of amplitude of the dominant frequency (highest peak) to amplitude at the frequency of the perturbation in a CPSD between the input signal and output estimate is a useful severity metric. As the value of this severity metric approaches zero, the severity is considered to increase. The severity metric approaches zero as a consequence of the perturbation frequency becoming more dominant in the output estimates, as occurs when following or spillover is present in the ML model. The severity metric is agnostic as to type of dependency and equally applicable to both types of dependency. This severity metrics may also be referred to as “robustness scores” for the ML model, indicating the extent to which the ML model is free from following or spillover between input and output variables.

Table 1 below contains metrics for following or spillover for the example databases described above with reference to FIGS. 3 and 4. Table 1 quantitatively summarizes the results of the transfer function analyses for the example databases. The left-hand column (“Post-Perturbation:Pre-Perturbation”) contains a ratio of CPSD amplitudes (at the frequency of the perturbation) of the signals after and before the perturbation was introduced. This may be referred to as a perturbation change ratio. In other words, the perturbation change ratio is the ratio between CPSD amplitudes at the signal frequency (or period) with the new peak and without the new peak (as discussed above). These Post- to Pre-Perturbation amplitude ratios illustrate the increase in magnitude that occurs as a consequence of the coupling effect. The right-hand column (“Dominant Freq.:Perturbation Freq.”) contains the severity metric discussed above, ratio of amplitude at the dominant frequency to amplitude at the frequency of the perturbation in the CPSD between input and output.

TABLE 1
Metric for Following and Spillover:
Ratio of CPSD Frequency Peaks

| | Database 1 (Perturbation only on Sig. #01) | |
|---|---|---|
| | Post-Perturbation: | Dominant Freq.: |
| | Pre-Perturbation | Perturbation Freq. |
| Sig. #01 | 4.37 | 634.28 |
| Sig. #02 | 4.54 | 737.57 |
| | Database 2 (Perturbation only on Sig. #01) | |
| | Post-Perturbation: | Dominant Freq.: |
| | Pre-Perturbation | Perturbation Freq. |
| Sig. #01 | 78.60 | 122.03 |
| Sig. #08 | 11.24 | 37.60 |

Recall that ML models trained from the first example signal database (database 1) exhibit little to no following. Accordingly, the Signal 1 ratio of post-perturbation CPSD amplitude to pre-perturbation CPSD amplitude at the frequency of the perturbation is small at 4.37. This small increase in magnitude indicates little coupling effect between the Signal 1 input and the Signal Â₁ output (estimates for Signal 1). Also, the severity metric is far from zero at 634.28. This large value indicates that the perturbation frequency at the Signal 1A input is not dominant in the Signal Â₁ output (estimates for Signal 1A). This indicates that following is not severe in the ML model for the first example signal database, and that following has little effect on ML model accuracy.

Recall that ML models trained from the first example signal database (database 1) exhibit little to no spillover. Accordingly, the Signal 2 ratio of post-perturbation CPSD amplitude to pre-perturbation CPSD amplitude at the frequency of the perturbation is small at 4.54. This small increase in magnitude indicates little coupling effect between the Signal 1 input and the Signal Â₂ output (estimates for Signal 2). Also, the severity metric is far from zero at 737.57. This large value indicates that the perturbation frequency at the Signal 1A input is not dominant in the Signal Â₂ output. This indicates that spillover between monitored signal 1 and estimates for signal 2 is not severe in the ML model for the first example signal database, and that this spillover has little effect on ML model accuracy.

Recall that ML models trained from the second example signal database (database 2) exhibit following. Accordingly, the Signal 1 ratio of post-perturbation CPSD amplitude to pre-perturbation CPSD amplitude at the frequency of the perturbation is large at 78.60. This large increase in magnitude indicates a strong coupling effect between the Signal 1 input and the Signal \hat{B}₁ output (estimates for Signal 1). Also, the severity metric is closer to zero at 122.03. This moderate value indicates that the perturbation frequency at the Signal 1B input is somewhat dominant in the Signal \hat{B}₁ output (estimates for Signal 1B). This indicates that following is moderately severe in the ML model for the second example signal database. The following therefore moderately detracts from ML model accuracy.

Recall that ML models trained from the second example signal database (database 2) exhibit spillover. Accordingly, the Signal 8 ratio of post-perturbation CPSD amplitude to pre-perturbation CPSD amplitude at the frequency of the perturbation is moderate at 11.24. This moderate increase in magnitude indicates a moderate coupling effect between the Signal 1 input and the Signal \hat{B}₈ output (estimates for Signal 8). Also, the severity metric is approaching zero at 37.60. This small value indicates that the perturbation frequency at the Signal 1A input is dominant in the Signal \hat{B}₈ output. This indicates that spillover between monitored signal 1 and estimates for signal 8 output is severe the ML model for the first example signal database. While the coupling effect is only moderate, the spillover effects nevertheless dominate the informational content of the Signal \hat{B}₈ estimates for Signal 8.

### Selected Advantages

In one embodiment, the dependency checking for ML model systems and methods described herein provides a superior methodology for proactively characterizing ML models (such as those used for prognostic anomaly detection) in terms of susceptibility to the deleterious effects of spillover and following on ML model accuracy. In one embodiment, this method improves over insertion of artificial anomalies (such as a simple ramp-type degradation) one-at-a-time into all signals to assess spillover and following. In one embodiment, sing the dependency checking for ML model systems and methods described herein therefore reduces computational cost of performing spillover and following analyses compared with repeated anomaly insertion analyses for all signals. Also, in one embodiment, because the oscillating perturbation (or other repeating probe signal) may be small in amplitude, the signals are not caused to have amplitudes outside of the training ranges for the model, thereby avoiding anomaly alerts that may compromise metrics for following or spillover. Further, in one embodiment, the systems and methods described herein can not only quantify the propensity of an ML model to exhibit following or spillover, but also accurately quantify the degree of the spillover or following.

In one embodiment, superimposing an oscillating perturbation onto input signals of an ML model allow the system to infer the influence of the oscillating perturbation on the output estimates of the model for all signals. In one embodiment, the repeating or periodic content of an oscillating perturbation makes even an oscillating perturbation of small magnitude detectable as a spike in the frequency domain. This is especially so when the spike is amplified by CPSD. Non-repeating perturbations applied to signals, such as step changes, need to be large in order to overcome the noise on the signal. In other words, imposing a step change or other blunt perturbation into one variable and then measuring response in other variables calls for a step change large enough that steps in the output variables are distinguishable from noise in the output variables.

It is extremely challenging to assess how changes to input signals of an ML model propagate through the ML model to affect the output signals. In one embodiment, the systems and methods herein resolve this challenge by inferring the effects of modifications to the input signals through the ML model to the output model estimates for those input signals. In one embodiment, the systems and methods herein directly characterize the propensity for following and spillover of an NLNP ML model with robustness scores.

### Cloud or Enterprise Embodiments

In one embodiment, the present system (such as model dependency check system 105) is a computing/data processing system including a computing application or collection of distributed computing applications for access and use by other client computing devices associated with an enterprise that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment model dependency check system 105 is a centralized server-side application that provides at least the functions disclosed herein and that is accessed by many users via computing devices/terminals communicating with the computers of model dependency check system 105 (functioning as one or more servers) over a computer network.

In one embodiment, the components of system 100 (including the components of model dependency check system 105) intercommunicate by electronic messages or signals. These electronic messages or signals may be configured as calls to functions or procedures that access the features or data of the component, such as for example application programming interface (API) calls.

In one embodiment, these electronic messages or signals are sent between hosts in a format compatible with transmission control protocol/internet protocol (TCP/IP) or other computer networking protocol. Components of system 100 may (i) generate or compose an electronic message or signal to issue a command or request to another component, (ii) transmit the message or signal to other components of computing system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by model dependency check system 105, for example through a web interface server. In one embodiment, the remote computing system may send requests to and receive responses from model dependency check system 105. In one example, access to the information or applications may be effected through use of a web browser on a personal computer or mobile device. In one example, communications exchanged with model dependency check system 105 may take the form of remote representational state transfer (REST) requests using JavaScript object notation (JSON) as the data interchange format for example, or simple object access protocol (SOAP) requests to and from XML servers. The REST or SOAP requests may include API calls to components of model dependency check system 105.

### Computing Device Embodiment

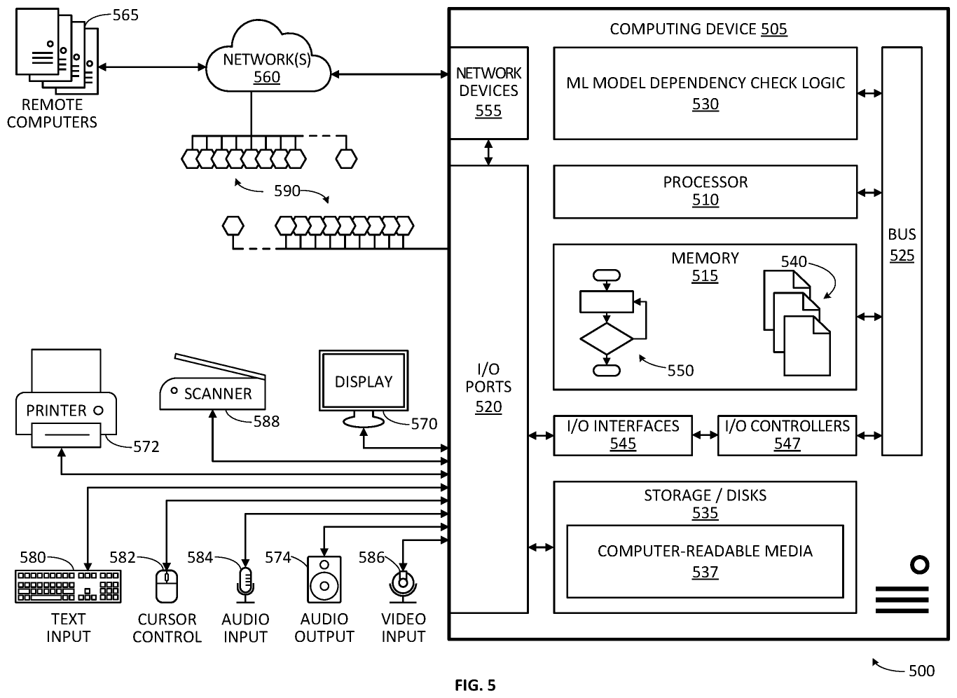

FIG. 5 illustrates an example computing system 500 that is configured and/or programmed as a special purpose computing device with one or more of the example systems and methods described herein, and/or equivalents. In one embodiment, example computing system 500 includes an example computer or computing device 505. Example computing device 505 may include at least one hardware processor 510, a memory 515, and input/output ports 520 operably connected by a bus 525. In one example, the computer 505 may include ML model dependency check logic 530 configured to facilitate checking for dependency phenomena (such as following and spillover) in ML models, similar to the logic, systems, and methods shown and described with reference to FIGS. 1-4.

In different examples, the logic 530 may be implemented in hardware, a non-transitory computer-readable medium 537 with stored instructions, firmware, and/or combinations thereof. While the logic 530 is illustrated as a hardware component attached to the bus 525, it is to be appreciated that in other embodiments, the logic 530 could be implemented in the processor 510, stored in memory 515, or stored in disk 535.

In one embodiment, logic 530 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to check for dependency in ML models as shown and described herein. The means may also be implemented as stored computer executable instructions that are presented to computer 505 as data 540 that are temporarily stored in memory 515 and then executed by processor 510.

Logic 530 may also provide means (e.g., hardware, non-transitory computer-readable medium that stores executable instructions, firmware) for performing checking for dependency in ML models as shown and described herein.

Generally describing an example configuration of the computer 505, the processor 510 may be a variety of various processors including dual microprocessor and other multi-processor architectures. A memory 515 may include volatile memory and/or non-volatile memory. Non-volatile memory may include, for example, ROM, PROM, and so on. Volatile memory may include, for example, RAM, SRAM, DRAM, and so on.

Storage or disks 535 may be operably connected to the computer 505 via, for example, an input/output (I/O) interface (e.g., card, device) 545 and an input/output port 520 that are controlled by at least an input/output (I/O) controller 547. The storage or disk 535 may be, for example, a magnetic disk drive, a solid state drive, a floppy disk drive, a tape drive, a Zip drive, a flash memory card, a memory stick, and so on. Furthermore, the storage or disk 535 may be a CD-ROM drive, a CD-R drive, a CD-RW drive, a DVD ROM, and so on. The memory 515 can store a process 550 (such as method 200) and/or a data 540, for example. The storage or disk 535 and/or the memory 515 can store an operating system that controls and allocates resources of the computer 505.

The computer 505 may interact with, control, and/or be controlled by input/output (I/O) devices via the input/output (I/O) controller 547, the I/O interfaces 545, and the input/output ports 520. Input/output devices may include, for example, one or more displays 570, printers 572 (such as inkjet, laser, or 3D printers), audio output devices 574 (such as speakers or headphones), text input devices 580 (such as keyboards), cursor control devices 582 for pointing and selection inputs (such as mice, trackballs, touch screens, joysticks, pointing sticks, electronic styluses, electronic pen tablets), audio input devices 584 (such as microphones or external audio players), video input devices 586 (such as video and still cameras, or external video players), image scanners 588, video cards (not shown), disks 535, network devices 560, and so on. The input/output ports 520 may include, for example, serial ports, parallel ports, and USB ports.

The computer 505 can operate in a network environment and thus may be connected to the network devices 555 via the I/O interfaces 545, and/or the I/O ports 520. Through the network devices 555, the computer 505 may interact with a network(s) 560. Through network 560, the computer 505 may be logically connected to remote computers 565. Networks with which the computer 505 may interact include, but are not limited to, a LAN, a WAN, and other networks.

In one embodiment, the computer may be connected to sensors 590 through I/O ports 520 or networks 560 in order to receive information about physical states of monitored machines, devices, systems, or facilities (collectively referred to as “assets”). In one embodiment, sensors 590 are configured to monitor physical phenomena occurring in or around an asset. The assets generally include any type of machinery or facility with components that perform measurable activities. In one embodiment, sensors 590 may be operably connected or affixed to assets or otherwise configured to detect and monitor physical phenomena occurring in or around the asset. The sensors 590 may be network-connected sensors for monitoring any type of physical phenomena. The network connection of the sensors 590 and networks 560 may be wired or wireless. The sensors 590 may include (but are not limited to): a voltage sensor, a current sensor, a temperature sensor, a pressure sensor, a scale or other weight sensor, a rotational speed sensor, an angle sensor, a distance sensor, a displacement sensor, a thermometer, a flow meter sensor, a vibration sensor, a microphone, a photosensor, an electromagnetic radiation sensor, a proximity sensor, an occupancy sensor, a motion sensor, a gyroscope, an inclinometer, an accelerometer, a shock sensor, a global positioning system (GPS) sensor, a torque sensor, a flex sensor, a moisture monitor, a liquid level sensor, an electronic nose, a nuclear radiation detector, or any of a wide variety of other sensors or transducers for generating telemetry—electrical signals that describe detected or sensed physical behavior.

In one embodiment, computer 505 is configured with logic, such as software modules, to collect readings from sensors 590 and store them as observations in a time series data structure such as a time series database. In one embodiment, the computer 505 polls sensors 590 to retrieve sensor telemetry readings. In one embodiment, the computer 590 passively receives sensor telemetry readings actively transmitted by sensors 590. In one embodiment, the computer 505 receives one or more databases of previously collected observations of sensors 590, for example from storage 535 or from remote computers 565.

### Definitions and Other Embodiments

No action or function described or claimed herein is performed by the human mind. An interpretation that any action or function can be performed in the human mind is inconsistent with and contrary to this disclosure.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
applying an oscillating perturbation to a test signal input into a machine learning model;
monitoring an estimate signal output from the machine learning model;
checking for the oscillating perturbation in the estimate signal; and
based on the results of the checking for the oscillating perturbation, presenting an evaluation of dependency in the machine learning model.

2. The computer implemented method of claim 1, wherein the checking for the oscillating perturbation further comprising:
performing a cross power spectral density transform on the test signal and the estimate signal;
examining the cross power spectral density at a frequency of the oscillating perturbation to determine whether a peak is present or absent at the frequency; and
in response to
(i) determining that the peak is present, indicating that the machine learning model inaccurately predicts the estimate signal in the evaluation of dependency; and
(ii) determining that the peak is absent, indicating that the machine learning model accurately predicts the estimate signal in the evaluation of dependency.

3. The computer implemented method of claim 1, further comprising:
inferring a coupling coefficient between the test signal and the estimate signal based on the oscillating perturbation; and
presenting the coupling coefficient in the evaluation of dependency.

4. The computer implemented method of claim 1, further comprising generating the oscillating perturbation as a sinusoidal waveform.

5. The computer implemented method of claim 1, further comprising:
automatically selecting an amplitude of the oscillating perturbation that is within a noise band of the test signal; and
generating the oscillating perturbation to have the amplitude.

6. The computer implemented method of claim 1, wherein the estimate signal predicts values for a second test signal input into the machine learning model, the method further comprising:
determining that the estimate signal erroneously predicts values for the second test signal that at least partially mimic the behavior of the test signal; and
indicating that the machine learning model is subject to spillover in the evaluation of the dependency of the machine learning model.

7. The computer implemented method of claim 1, wherein the estimate signal predicts values for the test signal, the method further comprising:
determining that the estimate signal erroneously predicts values that at least partially mimic the behavior of the test signal; and
indicating that the machine learning model is subject to following in the evaluation of the dependency of the machine learning model.

8. A non-transitory computer-readable medium that includes stored thereon computer-executable instructions that when executed by at least a processor of a computer cause the computer to:
apply an oscillating perturbation to a test signal input into a machine learning model;
monitor an estimate signal output from the machine learning model;
check for the oscillating perturbation in the estimate signal; and
based on the results of the checking for the oscillating perturbation, present an evaluation of dependency in the machine learning model.

9. The non-transitory computer-readable medium of claim 8, wherein the instructions to check for the oscillating perturbation further cause the computer to:
perform a cross power spectral density transform on the test signal and the estimate signal;
examine the cross power spectral density at a frequency of the oscillating perturbation to determine whether a peak is present or absent at the frequency; and
in response to
(i) determining that the peak is present, indicate that the machine learning model inaccurately predicts the estimate signal in the evaluation of dependency; and
(ii) determining that the peak is absent, indicate that the machine learning model accurately predicts the estimate signal in the evaluation of dependency.

10. The non-transitory computer-readable medium of claim 8, wherein the instructions further cause the computer to:
infer a coupling coefficient between the test signal and the estimate signal based on the oscillating perturbation; and
present the coupling coefficient in the evaluation of dependency.

11. The non-transitory computer-readable medium of claim 8, wherein the oscillating perturbation is sinusoidal.

12. The non-transitory computer-readable medium of claim 8, wherein the instructions further cause the computer to:
automatically select an amplitude of the oscillating perturbation that is within a noise band of the test signal; and
generate the oscillating perturbation to have the amplitude.

13. The non-transitory computer-readable medium of claim 8, wherein the estimate signal predicts values for a second test signal input into the machine learning model, and the instructions further cause the computer to:
determine that the estimate signal erroneously predicts values for the second test signal that at least partially mimic the behavior of the test signal; and
indicate that the machine learning model is subject to spillover in the evaluation of the dependency of the machine learning model.

14. The non-transitory computer-readable medium of claim 8, wherein the estimate signal predicts values for the test signal, and the instructions further cause the computer to:
determine that the estimate signal erroneously predicts values that at least partially mimic the behavior of the test signal; and
indicate that the machine learning model is subject to following in the evaluation of the dependency of the machine learning model.

15. A computing system, comprising:
at least one processor connected to at least one memory;
at least one network interface for communicating to one or more networks;
a non-transitory computer readable medium including instructions stored thereon that when executed by at least the processor cause the computing system to:
apply a repeating probe signal to an input signal input into a machine learning model;
monitor an estimate signal output from the machine learning model;
check for the repeating probe signal in the estimate signal; and
based on the results of the checking for the repeating probe signal, present an evaluation of dependency in the machine learning model.

16. The computing system of claim 15, wherein the instructions to check for the repeating probe signal further cause the computing system to:
performing a cross power spectral density transform on the input signal and the estimate signal;
examining the cross power spectral density at a frequency of the repeating probe signal to determine whether a peak is present or absent at the frequency; and
in response to
(i) determining that the peak is present, indicating that the machine learning model inaccurately predicts the estimate signal in the evaluation of dependency; and
(ii) determining that the peak is absent, indicating that the machine learning model accurately predicts the estimate signal in the evaluation of dependency.

17. The computing system of claim 15, wherein the repeating probe signal appears in the estimate signal, the instructions further cause the computing system to:
determine a severity metric between the input signal and the estimate signal, wherein the severity metric quantifies an extent to which dependency adversely affects accuracy of the estimate signal;
evaluate the severity metric to determine that a mitigation technique should be applied to the ML model; and
automatically implementing the mitigation technique.

18. The computing system of claim 15, wherein the instructions further cause the computing system to:
automatically select an amplitude for the repeating probe signal that is within a noise band of the input signal; and
generate the repeating probe signal to have the amplitude.

19. The computing system of claim 15, wherein the estimate signal predicts values for a second input signal input into the machine learning model, and wherein the instructions further cause the computing system to:
determining that the estimate signal erroneously predicts values for the second input signal that at least partially mimic the behavior of the input signal; and
indicating that the machine learning model is subject to spillover in the evaluation of the dependency of the machine learning model.

20. The computing system of claim 15, wherein the estimate signal predicts values for the input signal, and wherein the instructions further cause the computing system to:
determining that the estimate signal erroneously predicts values that at least partially mimic the behavior of the input signal; and
indicating that the machine learning model is subject to following in the evaluation of the dependency of the machine learning model.
